(19) United States
(12) Patent Application Publication
(10) Pub. No.: US 2014/0224792 A1
(43) Pub. Date: Aug. 14, 2014

(54) ADJUSTABLE WALL ENCLOSURE FOR ELECTRICAL DEVICES AND THE LIKE

(71) Applicant: Jurgen K. Beneke, Kingston, NY (US)

(72) Inventor: Jurgen K. Beneke, Kingston, NY (US)

(21) Appl. No.: 13/764,853

(22) Filed: Feb. 12, 2013

(51) Int. Cl. H02G 3/10

(52) U.S. Cl. CPC H02G 3/10
USPC 220/3.3

(57) ABSTRACT

Electrical wall outlets for switches, sockets and the like are provided with depth adjustability and the capability of providing a flush mounting to a wall or similar structure. The present invention comprises a relatively standard electric box together with a mesh for plaster which is supported by a frame which is slidably insertable into the box to a selectable depth. The invention is usable with or without supporting stud work.

### CROSS-REFERENCE TO RELATED APPLICATIONS

This application contains subject matter which is related to the subject matter of the following applications, each of which is assigned to the same assignee as this application. Each of the below listed applications is hereby incorporated herein by reference in its entirety:

Provisional patent application Ser. No. 61/634,726 filed on Mar. 5, 2012.

### TECHNICAL FIELD

The present invention is generally directed to enclosures for electrical outlets and switches. More particularly, the present invention is directed to electrical boxes which are flush mountable to any drywall structure. Even more particularly, the present invention is directed to electrical outlet enclosures which are adjustable, particularly as to depth. However, the present invention is not limited to installation of electrical devices nor to installations using drywall. Furthermore, while the present application is directed at installation within walls or ceilings, floor mounting is also possible.

### BACKGROUND OF THE INVENTION

Conventional installation of electrical outlets and switches (electrical devices) are not flush with the finished wall/ceiling surface. Usually the electrical device and it's cover is mounted on top of the finished wall/ceiling leaving it raised and standing out. Additionally, standard enclosures are hard to control as to depth once the box is attached to a stud or otherwise affixed to a wall.

The present invention allows an installer to place an electrical device within a wall/ceiling and adjust it to be flush with the future finish (for example, wall tile). Furthermore the present invention eliminates the problem of electrical boxes not needing to be 100% square to the wall/ceiling since a plaster ring is used which is itself alignable with the wall/ceiling surface. The present invention also allows for later adjustment. If, for example, another layer of plaster is used to skim out the wall/ceiling, the trim assembly can be moved out to align with the added layer of plaster. Another advantage is that, when installed in a tiled kitchen backsplash, cleaning is easier since one can wipe over the tile and outlet in one continuous move. It is also possible to completely blend the electrical device into the wall surface with wall paper or faux finishing techniques leaving no shadows or raised covers.

From the above, it is therefore seen that there exists a need in the art to overcome the deficiencies and limitations described herein and above.

### SUMMARY OF THE INVENTION

The present invention comprises an enclosure for use with a wall supported by studding and having an opening in the wall. The enclosure comprises a container having means for attachment to the studding. The container has an open side which is alignable with the opening in the wall. The invention also comprises a mesh for receiving plaster. The mesh is supported by a frame which fits into the open side of the container and is attachable thereto.

In one preferred embodiment of the present invention the enclosure also includes a mounting frame which is slidably insertable into the frame which supports the mesh.

In another preferred embodiment of the present invention, the enclosure is not affixed to studding but rather is insertable into a wall structure and is held in place therein by expandable tabs which lock the enclosure into place without the use of studs.

Accordingly, it is an object of the present invention to provide an electrical outlet or switch which is mounted flush with respect to a wall or ceiling.

It is another object of the present invention to provide improved installation methods for electrical switches and outlets.

It is yet another object of the present invention to provide an electrical enclosure which is capable of being fabricated using a variety of materials such as metal and plastic.

It is a still further object of the present invention to provide a flush mountable enclosure which is still nonetheless employable with existing, standard (electrical) components.

It is still another object of the present invention to provide an enclosure for electrical switches and outlets which is controllable as to depth, even after the enclosure itself has already been affixed to studding.

It is another object of the present invention to provide an enclosure for electrical switches and outlets which allows easy replacement of the electrical device it is designed to enclose.

Lastly, but not limited hereto, it is an even further object of the present invention to provide an electrical enclosure having an improved appearance and which is easier to clean.

Additional features and advantages are realized through the techniques of the present invention. Other embodiments and aspects of the invention are described in detail herein and are considered a part of the claimed invention. Again, while the objects of the present invention are described in terms of switches and outlets, other objects may be enclosed by the present invention, including, but not limited to thermostats, smoke detectors, fire detectors and/or various decorative items.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a front view of a completed installation within a wall or ceiling;

FIG. 2 is an exploded view illustrating an outlet box and trim assembly in accordance with the present invention;

FIG. 3 is a side view of a single box and trim assembly in accordance with the present invention;

FIG. 4 is a side view illustrating adjustability for plastering;

FIG. 5 is a side view similar to FIG. 4 but more particularly illustrating adjustability for installations in which tile is employed;

FIG. 6A is a front view illustrating a preferred structure for the container employed in accordance with the present invention (typically an electrical box which is employed as a stand-in for a conventional electrical box and also referred to herein, for convenience, as an “electrical box.”);

FIG. 6B is a side view of the container shown in FIG. 6A;

FIG. 6C is a top view of the container shown in FIG. 6A;

FIG. 7A is a front view of a mesh for receiving plaster (also referred to herein as a plaster ring) in accordance with the present invention;

FIG. 7B is a side view of the plaster receiving mesh seen in FIG. 7A;

FIG. 7C is a top view of the plaster receiving mesh seen in FIG. 7A;

FIG. 8A is a front view of a mounting frame (also referred to herein as an adjustable mounting cage) in accordance with the present invention;

FIG. 8B is a side view of the mounting frame seen in FIG. 8A;

FIG. 8C is a top view of the mounting frame seen in FIG. 8A;

FIG. 9A is a front view of a cover employable in conjunction with the present invention;

FIG. 9B is a side view of the cover shown in FIG. 9A;

FIG. 9C is a top view of the cover shown in FIG. 9A;

FIG. 10 is an isometric view of an embodiment of the present invention which does not involve the use of studding and more particularly illustrates an electrical box and trim assembly disposed within a wall portion distal from studding;

FIG. 11 is an isometric view of an electrical box in accordance with the present invention usable with or without studding and more particularly dimensioned for use with pair of switches or sockets;

FIG. 12 is an isometric view of an electrical box in accordance with the present invention in which the “box” is a round electrical box with trim and disposed within a wall, such as might be the case when the enclosed device is a thermostat or the like;

FIG. 13 is an isometric view of an electrical box in accordance with the present invention in which the electrical box is provided with back mounting (such as for use with concrete anchors);

FIG. 14 is an isometric view of an electrical box and trim in accordance with the present invention for installation in sheetrock without studs;

FIG. 15 front view of a completed installation within a wall, ceiling or even a floor;

FIG. 16 is an exploded view in accordance with the present invention illustrating the use of modified set screws for depth adjustment;

FIG. 17 is an exploded side view of assembly in accordance with the present invention which uses modified set screws for adjustment;

FIG. 18 is a side view illustrating the relevant portion of an assembly in accordance with the present invention which more particularly shows adjustability with modified set screws; and

FIG. 19 is a view similar to FIG. 18 but more particularly illustrating the adjustability of the present invention using modified set screws in an environment which includes tiles.

### DETAILED DESCRIPTION

In its most typical embodiment, the present invention is directed to an electrical box for the installation of electrical sockets and switches. As used herein, and as generally understood in the electrical hardware arts, an electrical box is typically a plastic or metal rectangular container intended to be affixed to a wall stud or otherwise mounted. Electrical wires feed into the box and connect to the electrical device which the box is designed to contain. However, it is noted that the present invention is suitable for use in walls, ceilings, and even floors. Additionally, it is noted that the present invention is capable of containing a wide variety of both electrical devices and nonelectrical devices. It is also noted that it is not necessary that the present invention be used in situations where electrical power is said to the device but rather is provided via batteries.

The present invention allows an installer to place an electrical device within a wall/ceiling/floor and adjust it to be flush with the future finish, even if that finish is ceramic tile (or other tiles for that matter). Furthermore, the present invention eliminates the problem of electrical boxes not needing to be 100% square to the wall/ceiling/floor since a plaster ring is employed which aligns itself with the mounting surface. The present invention also allows for later adjustment. If, for example, another layer of plaster is used to skim out the surface, the trim assembly is moved out to align with the added layer of plaster. Another advantage of the present invention is that, when installed in conjunction with a tiled kitchen backsplash, cleaning is easier since one can wipe over the tile and outlet in one consecutive stroke. It is also possible to completely blend the electrical device into the wall surface with wall paper or faux finishing techniques leaving no shadows or raised covers.

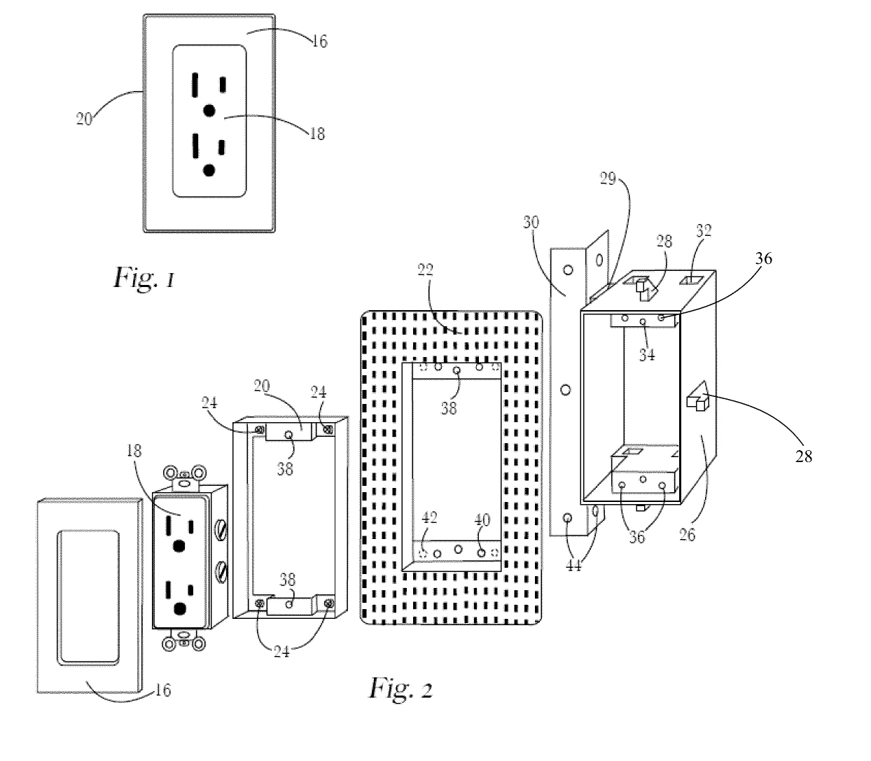

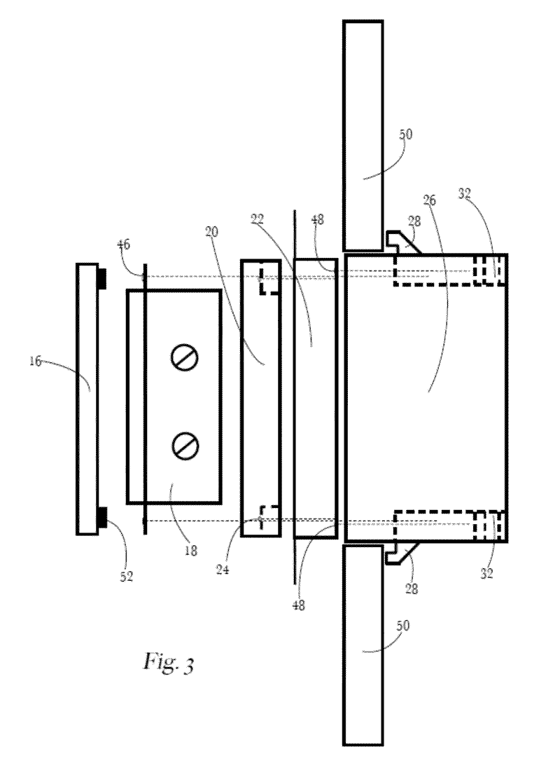

FIG. 1 illustrates the view of the present invention provided in a completed installation. In particular, electrical device 18, here illustrated as a three-prong electrical outlet, is seen surrounded by cover 16. Also visible in FIG. 1, there is seen the edge of adjustable mounting cage 20. Mounting cage 20 is also visible in FIG. 2.

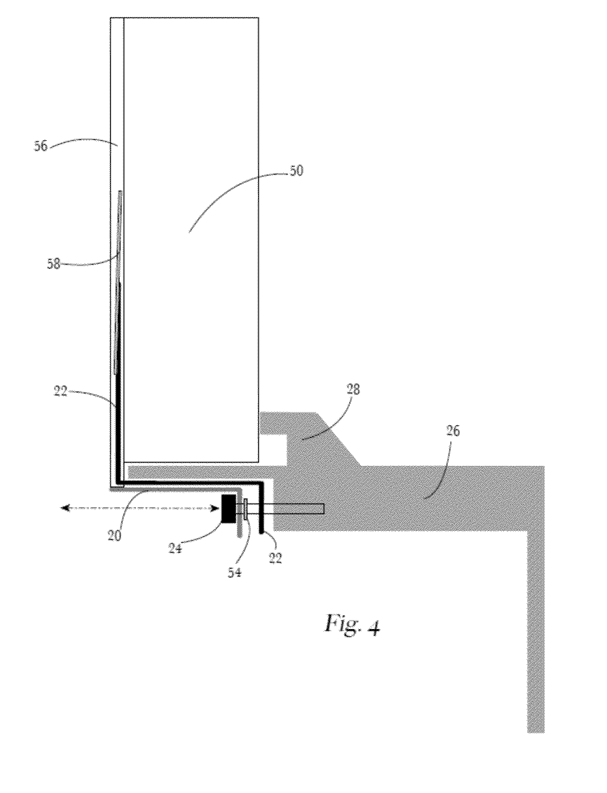

FIG. 2 provides an exploded view of a typical embodiment of the present invention. In particular, there is shown electrical box 26 along with mounting bracket 30 which is used to attach box 26 to framing studs (not shown). Mounting bracket 30 includes holes 44 used to attach box 26 to framing studs. This attachment may be accomplished by any convenient means including nails and screws. Mounting by means of adhesives is also consistent with the structure and utilization of the present invention although it is to be noted that such mounting is unconventional. Also seen in FIG. 2 is rotozip spacer 29 which is disposed between box 26 and bracket 30. In preferred installations, as they occur conventionally in the field, the front edge of box 26 is not perfectly flush with the outer surface of wallboard 50; however, its front edge is generally positioned so that it falls between the front and back surfaces of wallboard 50, close to its front edge. Electrical box 26 also preferably includes wedges 28 which are intended to fit flush against the wall board through which box 26 extends. Electrical box 26 also includes threaded openings 34 which are used for mounting electrical device 18. In particular, it is to be noted that electrical box 26 is intended to extend through a wall board to a degree sufficient to assure that, in the final installation, the front edge of electrical box 26 is disposed so as to be flush with the visible surface of the wall board. A wall board structure 50 is illustrated in FIG. 4.

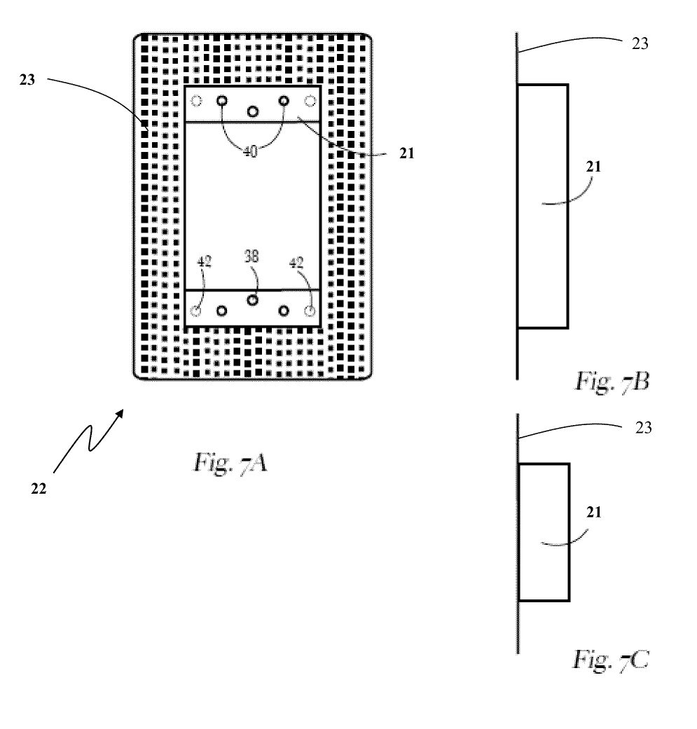

One of the principal features of the present invention is the presence of perforated plaster ring 22. Plaster ring 22 includes flat mesh portion 23 which is intended to lie flat against the mounting surface. The mesh portion is attached to frame portion 21 having various openings and threaded portions for attachment to electrical box 26. For detail see FIGS. 7A-7C, discussed below. In particular, plaster ring 22 includes an aperture such as opening 38 for mounting electrical device 18. Frame or support portion 21 of plaster ring 22 also includes aperture 40 through which a screw is disposable for attachment to electrical box 26. As shown in FIG. 2, electrical box 26 is provided with threaded openings 36 for receiving a screw or other fastening device disposed through opening 40. In this manner plaster ring 22 is affixable to electrical box 26. For reasons of potential overcrowding in FIG. 2, not all of the openings provided in plaster ring structure 22 are labeled. However, symmetry and logic provide clarity as to the functions associated with the openings shown. It is to be particularly noted that, in the present invention, plaster ring 22 is designed to be mated with electrical box 26 so that frame portion 21 of ring 22 extends into electrical box 26. Additionally, as is clear from FIG. 2, while the perforated plaster ring shown is referred to herein as a “ring,” it is not required that its shape be circular. In fact, mesh portion 21 of perforated plaster ring 22 may be provided in any desirable shape as long as it includes perforations and is designed to lie flat against the surface in which box 26 is mounted. It is also to be noted that frame portion 21 of plaster ring 22 also includes threaded apertures 42 which function to provide adjustability for mounting cage 20.

The present invention also preferably includes adjustable mounting cage 20 which is insertable into frame portion 21 of perforated plaster ring 22. It is this cage which provides the greatest degree of depth control and adjustability. It is noted that, like perforated plaster ring 22, mounting cage 20 also includes apertures 38 through which a fastener may be disposed for attachment of electrical device 18. Clearly, apertures 38 in mounting cage 20 and plaster ring 22 are lined with threaded opening 34 in box 26.

It is also to be particularly noted that mounting cage 20 also includes screws 24 that are used for depth adjustment. These screws aligned with apertures 42 in plaster ring 22. Apertures 42 in ring 22 provide a friction fit for screws 24. Screws 24 and threaded aperture 42 are designed so that the friction fit ensures that turning of screws 24 serves to move mounting cage 20 in a direction perpendicular to the mounting surface. In preferred embodiments of the present invention, screws 24 are provided with hexagonal openings for ease of adjustment. It is this aspect of the present invention which provides the desired degree of adjustability.

Lastly with respect to FIG. 2, electrical device 18 is disposed through openings in mounting cage 20 and plaster ring 22 so as to reside mostly in side of box 26. Cover 16 is placed with respect to device 18 so as to create a final finished view such as that shown in FIG. 1.

Attention is now directed to FIG. 3 which illustrates the same components as shown in FIG. 2, and again in an exploded view, but now more particularly illustrating a view from the side which more particularly indicates the placement of the various components relative to wallboard 50. While reference numeral 50 is referred to herein as a wallboard, is noted that, in general, it may comprise any wall, floor or ceiling surface. Once box 26 is disposed through an opening in wallboard 50 and electrical conductors are provided to it via access openings 32, the other components are inserted starting with plaster ring 22 which is affixed to electrical box 26 via screw 48. With respect to the installation of electrical box 26, it is typically mounted with mounting bracket 30 to the framing (studs) within the wall/ceiling/floor using stud screw holes 44. Subsequently, mounting cage 20 is affixed to plaster ring 22 using screws 24 which are used for adjustable depth positioning. Electrical device 18 is thereafter at some time inserted at least partially through ring 22 and cage 20 and is attached to box 26 via screws 46. Is noted that wedges 28 serve to better position box 26 rigidly with respect to wallboard 50. The installation is typically finished with the placement of cover 16. It is also to be particularly noted that, in the process described above, plastering operations intended to mesh with screen portion 23 of ring 22 may be begun at any time after installation of ring 22.

Attention is next directed to FIG. 4. Like FIG. 3 this view is intended to illustrate the arrangement of the various structures with respect to the mounting surface. However, unlike FIG. 3, FIG. 4 is not an exploded view and is further distinguished by the fact that it is an enlarged view. In particular, FIG. 4 illustrates electrical box 26 disposed through an opening in wallboard 50. FIG. 4 also illustrates perforated plastic ring 22 disposed in its intended position with screen portion 23 flush against wallboard 50 and with frame portion 21 inserted into box 26 so that frame portion 21 lies substantially below the outer surface of wallboard 50. Additionally, it is noted that adjustable mounting cage 20 is disposed within frame portion 21 of ring structure 22 and is positionable by means of screws 24 to control its depth with respect to the outer surface of wallboard 50. Also of note is the particular structure of screw 24 used for depth adjustment. It is also seen that snap ring 54 may be employed as a convenience to affix screws 24 to plaster ring 20. Other screw structures may also be employed.

FIG. 4 is also relevant in that it shows the relationship between the present invention and typical wall finishings. In particular, it is noted that FIG. 4 illustrates the presence of a layer of fiberglass tape 58 which is affixed to screen portion 23 of ring 22 and is also affixed to the outer surface of wallboard 50. Additionally, it is noted that a finishing layer of plaster 56 is applied and covers tape 58 and screen portion 23 of ring structure 22. Accordingly, it is seen that the present invention is consistent with conventional wall finishing procedures and materials.

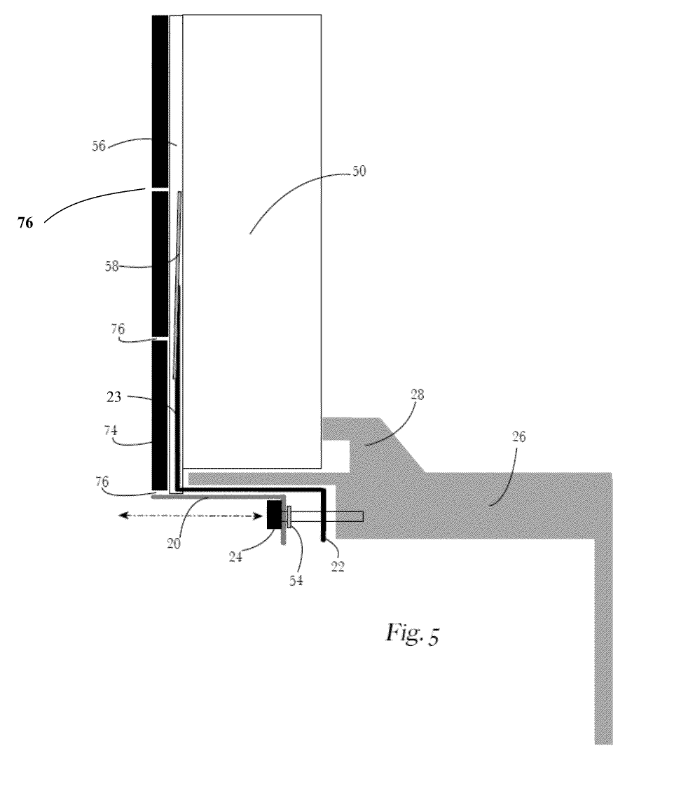

Attention is now directed to the view seen in FIG. 5. This figure is provided to illustrate the fact that the present invention is also employable in those situations where the surface it is used with comprises tile or a tile portion. In particular, tile 74 is seeing disposed over fiberglass tape 28 and screen portion 23 of perforated plastic ring structure 22. Also visible in FIG. 5 are grout spaces 76. It is in this particular environment where the present invention is seen to be especially useful since the depth of tiles can be vary significantly. This is because tiles are provided in numerous decorative styles.

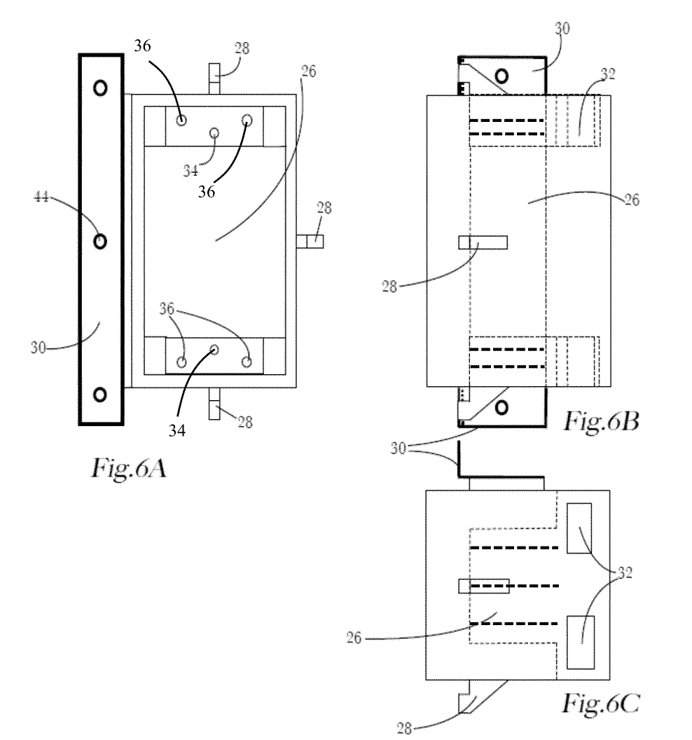

FIG. 6 provides three views of electrical box 26. In particular, there is shown front view FIG. 6A, side view FIG. 6B, and top view FIG. 6C. The primary function of this particular view is to illustrate the positioning of various ones of the holes or apertures for assembling the various components of the present invention. In particular, FIG. 6A illustrates openings 36 in both the top and bottom portions of box 26 which are employed for attaching plaster ring structure 22. Also seen are threaded openings 34 which are employed for mounting electrical device 18.

Electrical box 26 may comprise any convenient material including both metals and plastics. However, in those jurisdictions in which an electrical code is imposed, it may be necessary that electrical box 26 comprises a conductive metal such as iron, steel or even aluminum. Other components of the present invention are typically not subject to these constraints.

FIGS. 7 provides three views of perforated plaster ring structure 22. In particular, there are provided a front view, a side view and a top view: FIGS. 6A, 6B and 6C, respectively. Like FIG. 6, FIG. 7 is intended to illustrate the placement of various openings in frame or support portion 21 of perforated plaster ring structure 22. More particularly, there are shown threaded openings 42 which provide a friction fit for screws used to adjust mounting cage 20. Apertures 38 are provided for a screw which may be used for attachment of electrical device 18. Apertures 40 are provided for screws which are used to attach perforated plaster ring structure 22 to electrical box 26. Because of space limitations in the diagram, not all of the apertures are labeled. However, from placement and symmetry, the function of each of the apertures shown is clear.

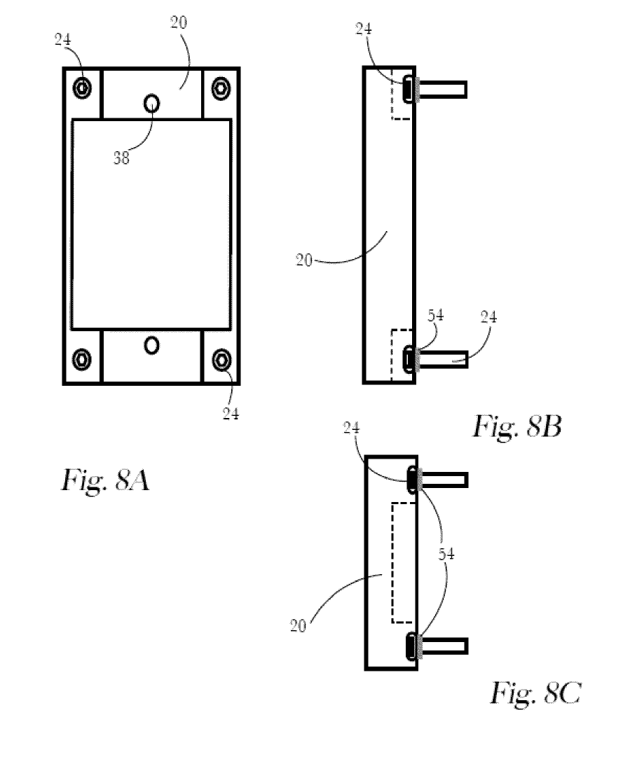

FIG. 8 provides a front, side and top view of mounting cage 20: FIGS. 8A, 8B an 8C, respectively. In particular there are shown screws 24 which are employable for these adjustments of depth for mounting cage 20. Other structures are labeled in accordance with the discussions elsewhere herein. Mounting cage 20 may comprise any convenient material including metals and plastics.

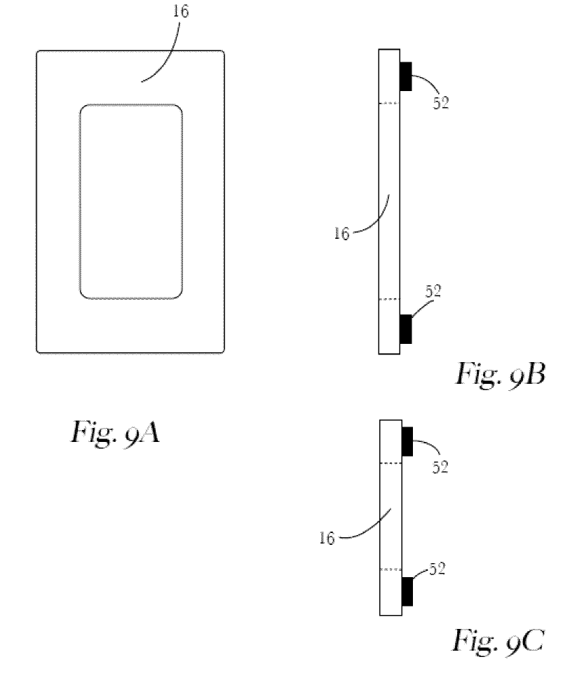

FIG. 9 provides a front, side and top view of cover 16: FIGS. 9A, 9B an 9C, respectively. Cover 16 is intended to be the last item to be installed. In particular, this installation may be accomplished through the utilization of magnetic or clip 52. Cover 16 may comprise any convenient material but in typical installation of the present invention is likely to be comprised of plastic.

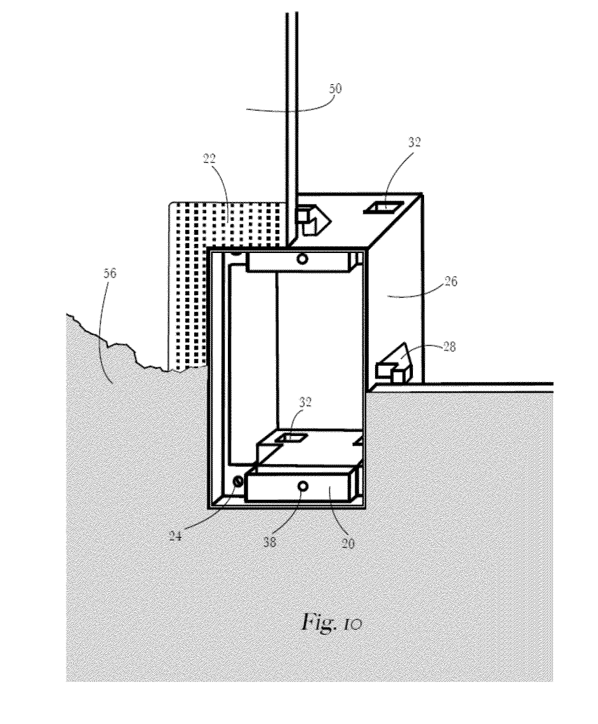

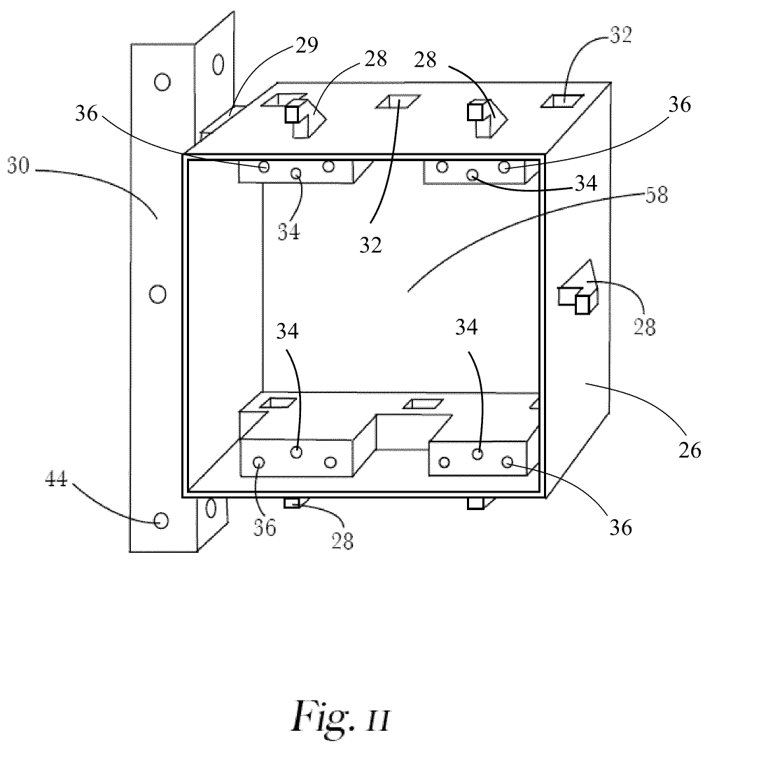

FIG. 10 illustrates a completed point in the installation of the present invention. In particular, electrical box 26 is shown disposed through an opening in wallboard 50 which is covered with finish coat of plaster 56 which has been smoothed into openings in screen portion 23 of perforated plaster ring 22 structure. Additionally, adjustable mounting cage 20 is shown in position prior to the installation of the device 18. Not shown are electrical conductors which are disposed through wire access openings 32. Also not shown is a stud behind the wallboard used for mounting as described above.

FIG. 11 is intended to illustrate the fact that the present invention is not limited to an electrical box intended for the inclusion of just one electrical device. In particular, FIG. 11 illustrates an electrical box which is intended for dual devices. Clearly, the extension to an even larger number of less devices is apparent from the structure shown in FIG. 11. The structure shown therein are labeled in the same manner as in other diagrams as discussed above.

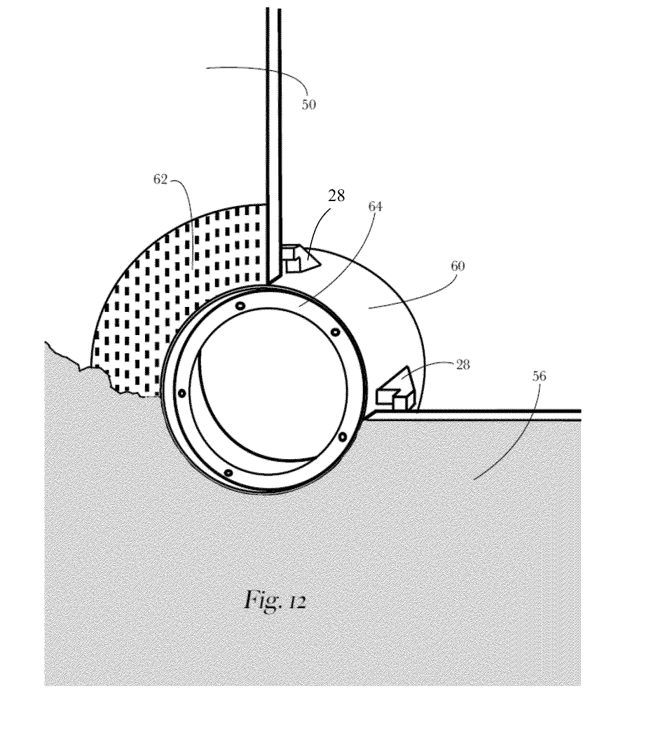

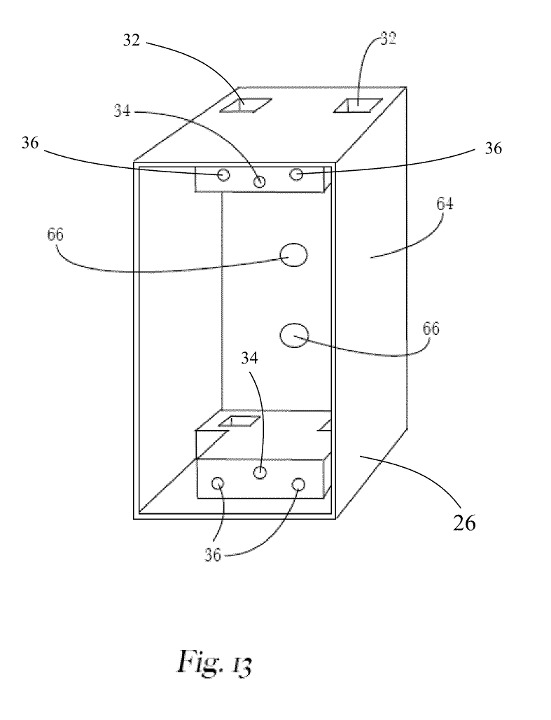

FIG. 12 illustrates the fact that electrical box 26 of the present invention may not be rectangular. In particular FIG. 12 illustrates the utilization of round box 60. Correspondingly, in this particular embodiment perforated plaster ring structure 22 is replaced by round plaster ring structures 62. Other related structures shown in FIG. 12 bear the same relation to the present invention as those structures and drawings discussed above.

FIG. 13 illustrates an alternative embodiment of the present invention in which apertures 66 are provided for anchoring electrical box 26 to a structure which lies behind it. For example, this embodiment may be employed to attach electrical box 26 two a concrete or cinderblock structure.

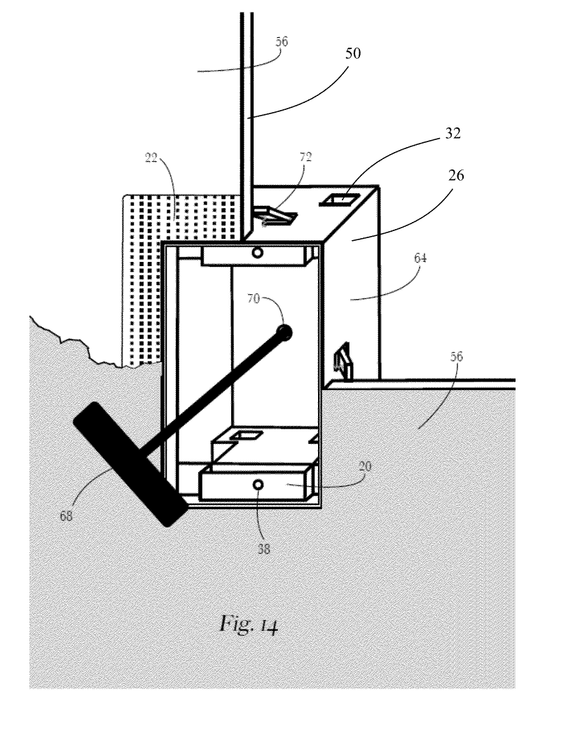

FIG. 14 illustrates an alternative method of installing electrical box 26. In this particular embodiment previously described wedges 28 are replaced by flip-up wedges 72. In this particular embodiment, electrical box 26 is also provided with threaded aperture 76 into which threaded T-handle 68 is inserted. This handle is used to hold electrical box 26 as it is inserted through the opening in wallboard 50. In this particular embodiment, electrical box 26 is also ultimately held in place by means of perforated plaster ring structure 22. Nonetheless, FIG. 14 illustrates the fact that the present invention does not require studding for its installation. With flip-up wedges 72 and T-handle 68 with threaded rod for inserting box 26 and pulling backward to meet sheetrock 50 it is thus seen that the present invention may be employed without the presence of nearby wall studs (or corresponding floor or ceiling joists).

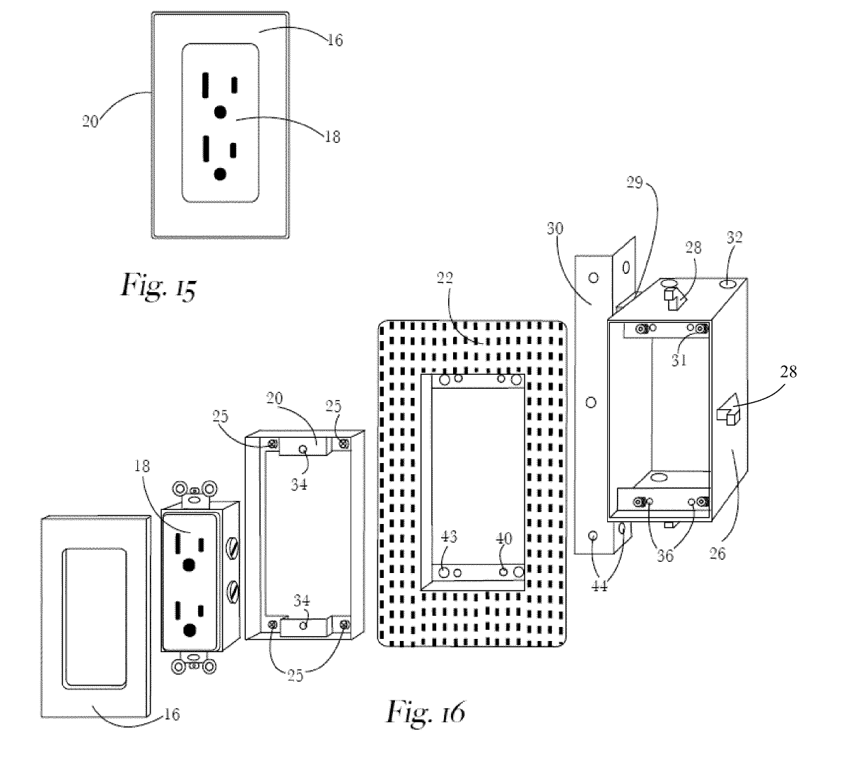

FIG. 15 illustrates a finished installation and is sufficiently shown in conjunction with FIG. 16 to more fully illustrates the structure and installation of a finished electrical socket. Also relevant is the fact that FIG. 16 illustrates an exploded view of the various components of the present invention mainly electrical box 26, perforated plaster ring structure 22 and adjustable mounting cage 20. Also of note is the inclusion of modified set screws 31 which are employed with and which operate in conjunction with screws 25. In particular, screws 25 are intended to school into the backs of screws 31. In this particular embodiment, the stability is provided primarily via screws 31.

While FIG. 16 at first appears to be a duplicate of FIG. 2, the difference is seen in the presence of hole 43 for providing access to “modified” set screws 31. In this particular embodiment set screws 31 are threaded into electrical box 26 in the usual openings (see reference numeral 42 in FIG. 2). However, set screws 31 are especially modified so that their cap ends also include a threaded female portion. Screws disposed through openings 43 in perforated plaster ring 22 are employed to affix this ring to the electrical box. These particular screws are not intended to provide depth adjustability in this embodiment. Rather, adjustability is provided by controlling the depth of insertion of modified set screws 31 electrical box 26. Set screws 31 are similar to standard hex head screws except that the hexagonal drive portions are replaced by a threaded female portion. Such screws are available as off-the-shelf items.

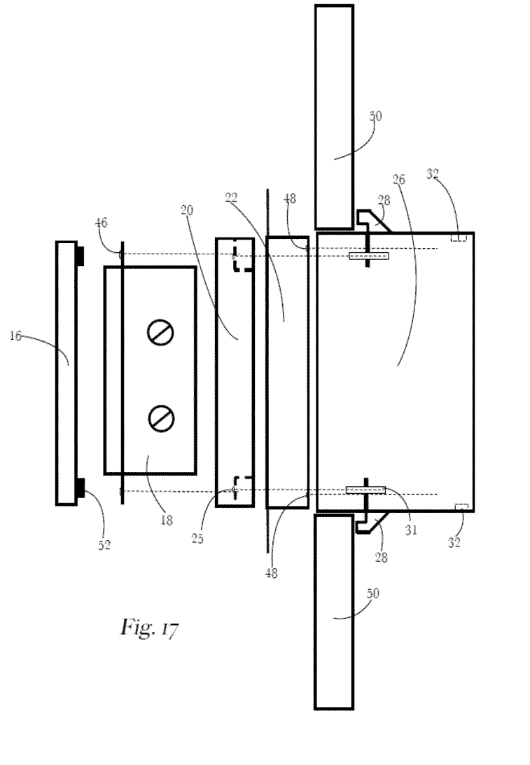

FIG. 17 provides an exploded side view of an installed embodiment of the present invention shown in FIG. 16. In particular, FIG. 17 illustrates the utilization of the modified set screws discussed above. Also, FIG. 17 illustrates the presence of screw 25 that fastens into modified set screws 31. Additionally shown in FIG. 17 is the presence of screws 48 which are intended to affix plaster ring structure 22 to box 26. Lastly, FIG. 17 illustrates the presence of screw 46 which is intended to affix electrical device 18 to electrical box 26. Other structures illustrated in FIG. 17 are described herein in accordance with reference numerals corresponding to those discussed above.

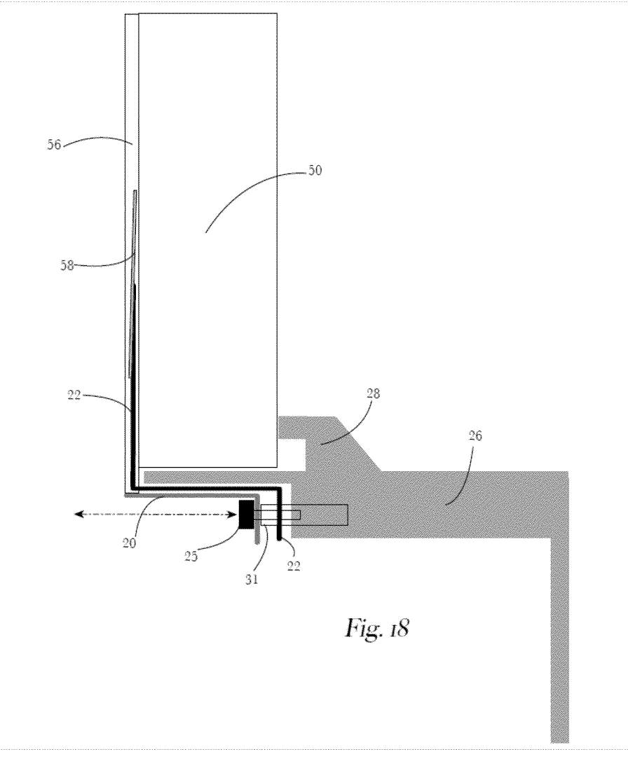

FIG. 18 is a view similar to FIG. 5 discussed above. However, in this particular view, the utilization of modified setscrew 31 and screw 25 inserted into setscrew 31 is more particularly illustrated. In particular, the adjustability of mounting cage 20 is seen to be provided by varying the depth of insertion of modified setscrew 31.

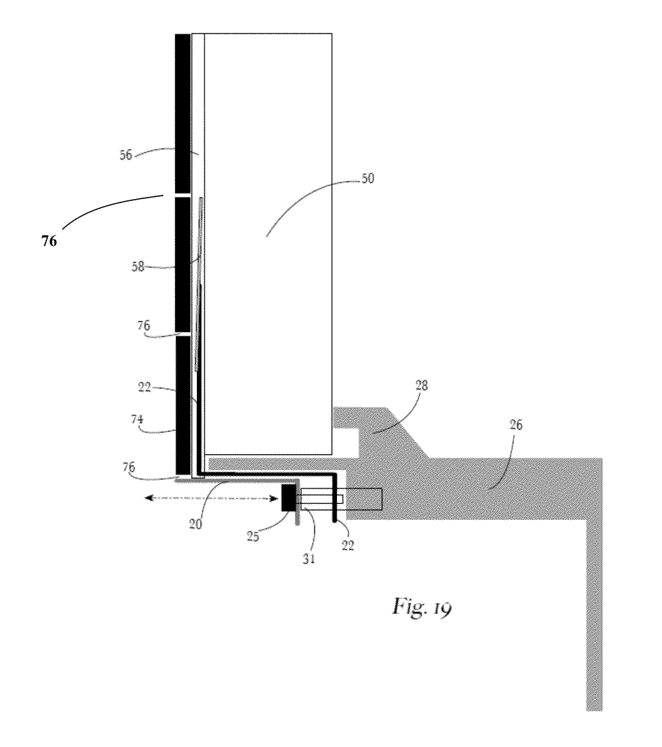

FIG. 19 is similar to both FIGS. 18 and FIG. 5. In particular, FIG. 19 illustrates the utilization of modified set screws for the depth adjustment in an environment in which wallboard 50 is provided with a tile finish.

Attention is now directed to a description of installation methods for the present invention. However, it is to be particularly noted that differences in installation are relatively minor and that the present invention is consistent with standard practices in the industry. Just like with a standard electrical box the wall board is hung over box 26 and later with rotozip blade 29, which fits thru the gaps at the bottom of wedges 28 and space between mounting bracket 30 and electrical box 26, cut out. After that perforated plaster ring 22 is fastened with screws that go thru the holes 40 into threads 36 to electrical box 26. This sandwiches wall board 50 between wedges 28 and screen portion 23 of perforated plaster ring 22. Then, the adjustable mounting cage 20 is fastened with screws 24 for depth adjustment relative to perforated plaster ring 22. Threads with friction 42 keep screws 24 for depth adjustment in the desired position. Screws 24 for depth adjustment are permanently fixed to adjustable mounting cage 20 with a snap ring 54. As discussed above, an alternate option for depth adjustment is the use of modified set screws with internal threads and hex key 31 which is installed as shown in FIG. 18 and FIG. 19.

Set screw 31 is threaded in box 26 and held in the desired location by means of friction or a lock-tite mechanism. In yet another embodiment, the top of the set screw is allowed to pass thru the hole 43 in plaster ring 22 where it pushes against the bottom of adjustable mounting cage 20 giving it the desired elevation for installation. The adjustable mounting cage 20 is fastened to the modified set screw 43 with screw 25.

Fiberglass tape 58 is then placed 1/2 on screen portion 23 of the perforated plaster ring 22 and 1/2 on wall board 50 as shown in FIGS. 4 and 5. Now the entire wall is skimmed with setting type compound like Durabond® or any other convenient compound used for plastering to provide a finished veneer plaster base-coat.

For tiling installations, adjustable mounting cage 20 is adjusted out to where its front edge is on the same plane with the finished tile 74. In this case, the gap between last tile 74 and adjustable mounting cage 20 is treated like grout space 76.

Electrical device 18 is attached via screws through screw holes 38 as provided and are inserted into threaded openings 34 located in electrical box 26. The final touch is to place the cover 16 with its four magnets or clips 52 on the corresponding heads of the screws for depth adjustment. Cover 16, the front edge of the adjustable mounting cage 20 and the face of the electrical device 18 are now be on the same plane with the finished wall plaster 56 or tile 74.

For purposes of clarification, particularly as it relates to language found in the claims below, is noted that the structure that supports mesh or screen 23 is also referred to herein as the mesh supporting frame. See reference numeral 21 in FIG. 7. This is in order to distinguish it from mounting frame 20 as shown in FIG. 2.

Also, it is noted that the materials employed for the fabrication of the different component of the present invention are primarily dictated by electrical codes as present in various state and national jurisdictions. This is particularly true of the container or a box 26. However, in the broadest scope of the invention, the components may comprise any convenient material including metals, plastics and even glass fiber composites. The only significant requirement for a material is that it be substantially rigid. However, even this requirement is relaxed for screen 23 itself.

Many other variations on the invention are possible. For example light fixtures, thermostats, medicine cabinets and other devices are now easily installable into walls/ceilings/floors using the same principals employed in this invention, thus making them flush and/or adjustable to the finished surface treatment.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC §112, sixth paragraph, unless the element is expressly recited using the phrase “means for.”

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. An enclosure for use with a wall supported by studding, said wall having an opening therein, said enclosure comprising:
a container having means for attachment to said studding, said container having an open side accessible through said wall opening; and
a mesh for receiving plaster, said mesh being supported by a mesh supporting frame which fits into said open side of said container and is attachable thereto.

2. The enclosure of claim 1 further including:
a mounting frame slidably insertable into said mesh supporting frame.

3. The enclosure of claim 1 in which said container is composed of a material selected from the group consisting of metal, plastic and fiberglass.

4. The enclosure of claim 2 in which said mesh supporting frame is composed of a material selected from the group consisting of metal, plastic and fiberglass.

5. The enclosure of claim 2 in which said mounting frame is composed of a material selected from the group consisting of metal, plastic and fiberglass.

6. The enclosure of claim 1 in which said mesh is composed of a material selected from the group consisting of metal, plastic and fiberglass.

7. The enclosure of claim 1 in which said container is rectangular.

8. The enclosure of claim 1 in which said container is circular.

9. The enclosure of claim 2 further including means for controllably fixing insertion depth for said mounting frame into said mesh supporting frame.

10. An enclosure for use with a wall, said enclosure comprising:
a container having means for attachment to said wall, said container having an open side accessible through an opening in said wall; and
a mesh for receiving plaster, said mesh being supported by a mesh supporting frame which fits into said open side of said container and is attachable thereto.

11. The enclosure of claim 10 in which said means for attachment comprises flexible tabs extending from exterior portions of said container.

12. The enclosure of claim 10 further including:
a mounting frame slidably insertable into said mesh supporting frame.

13. The enclosure of claim 10 in which said container is composed of a material selected from the group consisting of metal, plastic and fiberglass.

14. The enclosure of claim 10 in which said mesh supporting frame is composed of a material selected from the group consisting of metal, plastic and fiberglass.

15. The enclosure of claim 10 in which said mounting frame is composed of a material selected from the group consisting of metal, plastic and fiberglass.

16. The enclosure of claim 10 in which said mesh is composed of a material selected from the group consisting of metal, plastic and fiberglass.

17. The enclosure of claim 11 in which said mesh supporting frame includes apertures for at least one fastening device for affixing said supporting frame to said container, whereby said enclosure is held in place by combination of said tabs and said mesh supporting frame.
